(19) United States
(12) Patent Application Publication
(10) Pub. No.: US 2015/0294227 A1
(43) Pub. Date: Oct. 15, 2015

(54) DYNAMIC RULE BASED AIRCRAFT CATERING LOGISTICS SYSTEM

(71) Applicant: e-gatematrix, llc, Reston, VA (US)

(72) Inventors: Simon Digby-Jones, Taren Point (AU); Hemantha Coomasaru, Petersfield (GB); Michael Weldon, College Park, GA (US)

(21) Appl. No.: 14/514,180

(22) Filed: Oct. 14, 2014

Related U.S. Application Data
(60) Provisional application No. 61/890,610, filed on Oct. 14, 2013.

(51) Int. Cl. G06N 5/04; H04L 29/06; B64D 11/00

(52) U.S. Cl. CPC G06N 5/046; B64D 11/00; H04L 67/42

(57) ABSTRACT

A galley planning system generates loading plan configurations to facilitate the loading of the aircraft galleys for individual flights. The system applies up to date flight schedule data to one or more exchange rules to determine one or more exchange codes. Moreover, the system determines template containers that are associated with each of the one or more exchange codes and also determines a particular tangible container that corresponds to each template container. The system generates a loading plan configuration that indicates a list of determined containers to be loaded into the galley of the aircraft and a location within the galley for each determined container to be stored.

### FIELD OF THE DISCLOSURE

The present disclosure relates to aircraft catering logistics and more specifically, to determining one or more containers needed to supply the passengers of a particular flight based rule driven processing of flight data and generating a loading plan configuration that provides optimal container layout within the galley of the particular flight.

### BACKGROUND

Tens of thousands of aircraft, watercraft, railcars, vehicles, etc. carry passengers all over the world each day. In addition to properly operating and maintaining these vessels and vehicles, common carriers must attend to their passengers' needs (e.g., refreshments, etc.) while also, if desirable, provide goods for sale, such as duty free goods, theater tickets, jewelry, etc. to their passengers. In order to offer these various refreshments and products to passengers while in transit, each vessel must be loaded with all the goods needed for the duration of the trip prior to departure. Furthermore, some goods, such as perishable foods for example, may require an accompanying container to properly store the food and/or accompanying dishware, flatware, cart, etc. or to serve the food to a passenger.

While the logistics of loading the proper type and numbers of containers, beverages, equipment, etc. remains daunting, the configuration or the layout of the these containers within the galley proves equally difficult. For example, one must take into account the weight and the volume of each container, cart, etc. and account for the physical limitations of the possible configurations of containers, equipment, the size and type of galley (e.g., only five drawers may fit into a cart, a maximum of eight containers can be placed in drawer, etc.). Thus, not only must products for a particular itinerary be determined based on a potentially diverse group of passengers' desires and tastes, but the subsequent logistics necessary must be in place to configure the proper types of containers based on the space and weight limitations.

In conventional galley planning systems, these factors and limitations are managed by creating hundreds of catering specification documents for each flight, trip, etc. route. Because airlines, ferry/cruise lines, rail lines, bus lines, etc. modify their routes, itineraries, and patterns at least on a monthly basis, these catering specification documents are required to be updated frequently. Additionally, maintaining these hundreds of documents is labor intensive and prone to error because of the sheer scale of the operations of some airlines, rail lines, cruise lines, bus lines, etc. Moreover, the lack of standardized terms, descriptions, and part numbers that is found in these catering specification documents significantly impacts the ability to manage inventory properly. For example, a particular bowl may be labeled a “fruit bowl”, “cereal bowl”, “ice cream bowl”, etc. all within the same document. This leads to inefficient usage of equipment, increases issues at the time the galley is loaded, and hampers the ability to accurately perform weight calculations for aircraft balancing, for example.

### SUMMARY

A computer-implemented method for generating one or more loading plan configurations for loading one or more galleys of a corresponding one or more flights receives, via a digital communication network, flight schedule data for at least one flight, the flight schedule data including a plurality of flight attributes associated with the at least one flight. Moreover, in response to receiving the flight schedule data, the method determines one or more exchange rules based on the received plurality of flight attributes associated with the at least one flight and determines one or more exchange codes based on each of the determined one or more exchange rules, the one or more exchange codes associated with the at least one flight. Furthermore, the method determines one or more template containers that are associated with each of the one or more exchange codes and determines a particular container that corresponds to each of the one or more template containers, each container corresponding to a tangible item capable of being loaded into an aircraft. The method generates a loading plan configuration that indicates i) a list that includes each determined particular container to be loaded and ii) a location within the galley of the aircraft for each determined particular container to be stored and transmits, via the digital communication network, the loading plan configuration for the at least one flight.

A computer-readable medium having instructions stored thereon and executable by one or more processors to perform a method for generating one or more loading plan configurations for loading one or more galleys of a corresponding one or more flights, the method includes receiving, via a digital communication network, flight schedule data for at least one flight, the flight schedule data including a plurality of flight attributes associated with the at least one flight. In response to receiving the flight schedule data, the method includes determining one or more exchange rules based on the received plurality of flight attributes associated with the at least one flight and determining one or more exchange codes based on each of the determined one or more exchange rules, the one or more exchange codes associated with the at least one flight. Furthermore, the method includes determining one or more template containers that are associated each of the one or more exchange codes and determining a particular container that corresponds to each of the one or more template containers, each container corresponding to a tangible item capable of being loaded into an aircraft. Moreover, the method includes generating a loading plan configuration that indicates i) a list that includes each determined particular container to be loaded and ii) a location within the galley of the aircraft for each determined particular container to be stored and transmitting, via the digital communication network, the loading plan configuration for the at least one flight.

### BRIEF DESCRIPTION OF THE DRAWINGS

FIG. 1 shows an example of a system that may facilitate rule based galley planning in accordance with an aspect of the present disclosure;

FIG. 2 shows an example of a process for implementing rule based galley planning utilizing loading plan profiles in accordance with an aspect of the present disclosure;

FIG. 3 shows an example of a process for implementing rule based galley planning utilizing a rules engine in accordance with an aspect of the present disclosure;

FIG. 4 shows an example of a graphical depiction that may be representative of aspects of a process for implementing rule based galley planning in accordance with an aspect of the present disclosure;

FIG. 5 shows an example of a loading plan report in accordance with an aspect of the present disclosure;

FIG. 6 shows an example of a virtual container management interface that may be used to manage the contents of a particular virtual container in accordance with an aspect of the present disclosure;

FIG. 7 shows an example of an exchange rule management interface that may be used to manage exchange rules in accordance with at least one aspect of the present disclosure; and

FIG. 8 shows an example of a virtual container assignment interface in accordance with an aspect of the present disclosure.

### DETAILED DESCRIPTION

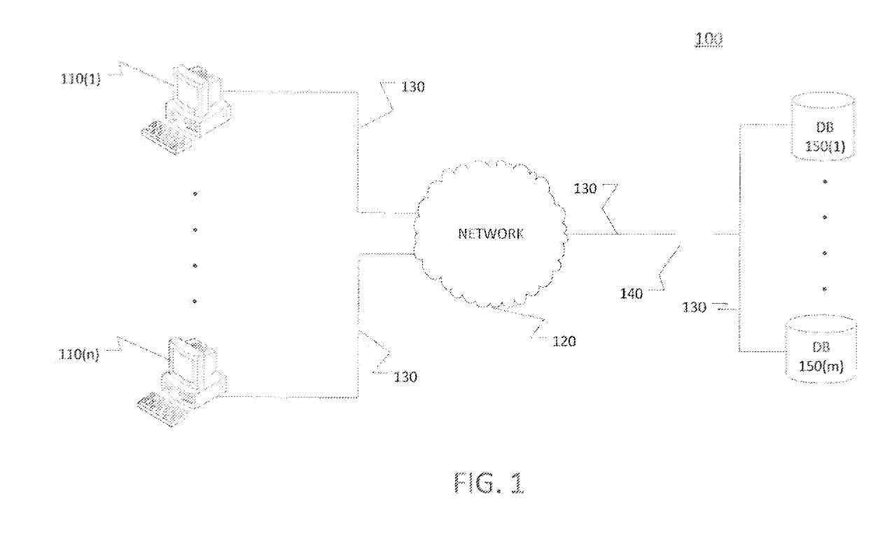

FIG. 1 is a high level block diagram that illustrates a computing environment for a galley planning system 100 that may be used to facilitate rule based galley planning. The galley planning system 100 includes one or more client computers 110(l)-110(n) that are communicatively coupled to a server 140, which in turn, is communicatively coupled to one or more databases 150(l)-150(m) through a communication network 120 and one or more communication links 130. Each client computer 110 may include, for example, a processor (not shown), a memory (not shown), and a computer readable medium or storage unit (not shown) of any desired type or configuration. The memory of each galley planning client 110 may execute a browser or store a client application that may request or may receive loading plan configurations from the server 140. The communication network 120 may include, but is not limited to, any combination of a LAN, a MAN, a WAN, a mobile, a wired or wireless network, a private network, or a virtual private network.

Alternatively, or in addition, an additional server (not shown) and/or an additional database (not shown) may be connected to each other and/or to the network 120 via the one or more communication links 130 (hereinafter “extended services server”). Each galley planning client 110 may include one or more of a variety of types of automated devices, such as, for example, a robot, robotic hardware, an automated actuator, etc. Alternatively, or in addition, the client computer 110 may be utilized by a carrier (e.g. airlines, bus lines, train operators, cruise lines, etc.) or may be used by a caterer that may be responsible for loading containers onto an aircraft, a vessel, a train, or a vehicle.

Server 140 may include one or more servers that may facilitate execution of a particular carrier's core data processing activities. A carrier's core data processing activities may include any data processing that may occur in association with the day-to-day operation of the carrier. Such core data processing activities may require the server 140 to access the database(s) 150. Moreover, the server may execute, via a processor, a rules engine that may process flight schedule data, flight attribute data, etc. to determine one or more appropriate virtual containers (e.g, template containers, configuration containers, object containers, or any generic container that defines the structure and hierarchy of a container and/or sub-containers).

The database 150 may store data including, among other things, files, records, information, objects, metadata, applications, etc. that are associated with, and/or corresponding to, a particular carrier. Such data may include data that is representative of, or otherwise associated with, one or more containers, container inventory data, virtual containers (e.g., template containers), virtual sub-containers (e.g., template sub-containers), exchange rules, exchange codes, loading plan profiles, loading plan reports (e.g., also referred to as loading plan configurations), trip (e.g., flight, rail trip, delivery route, etc.) specific parameters, flight attributes (e.g., any type of data specific to a particular flight/trip leg), customer specific information, customer orders, or any other suitable type of data. A loading plan configuration may include a galley diagram that graphically and realistically depicts each compartment and the container, item, equipment, etc. that is stowed in each compartment of a particular galley. Moreover, the loading plan configuration may include a packing diagram, or in the alternative, a packing diagram may be generated separately. The packing diagram may graphically and realistically depict each item that is to be packed into a container or a sub-container and may include the hierarchy of each container and sub-container. For example, the packing diagram may illustrate that a particular drawer sub-container includes twenty bowls, another particular tray sub-container may store twelve cutlery pack sub-containers, and a cart container may store six drawer sub-containers and one tray sub-container. A packing list may also be generated that lists each item and a quantity necessary for that item so that a caterer may be aware of the total quantities and items needed to pack an aircraft, watercraft, railcar, vehicle, etc.

As indicated above, the databases 150, which may be stored in or may be separate from the server 140, may contain a plurality of categories of information, including, for example, aircraft, vessel, railcar, vehicle information such as, e.g., galley diagrams, stowage summaries, galley configurations, beverage information, provisioning information, meal information, and any other type of data. Advantageously, the galley planning system 100 allows for an airline, a caterer, etc. to receive a wide range of information in a concise format that consolidates information regarding the plurality of categories of information by taking into consideration containers that may be shared across a vehicle fleet (e.g., aircraft, vessel, fleet) and listing them once, while identifying all relevant vehicles. The galley planning system 100 allows a user to create a virtual container (i.e., a generic template container) that is not tied to any one particular aircraft but is a model or template for one particular type or model of aircraft. For example, a template container may be created for the galley configuration of the aircraft model, Boeing 777. On the other hand, in continuing this example, a container may be created from this template container by tying the container to a particular Boeing 777 flight number 1976 flown by Delta Airlines.

Server 140 and database(s) 150 may be located at any geographical location, or distributed amongst a plurality of disparate geographical locations, so long as server 140 and database(s) 150 may be sufficiently configured to facilitate each respective core data processing activity that may be requested by client computer 110. Client computer 110 or server 140 may also be configured to interact with the extended services server in order to access, store, or modify data that resides within database(s) maintained by extended services server. The extended services server's database may store data that includes, among other things, carrier records, loading plan reports, customer orders, all types of data that may be stored in database 150, mirrored versions of the data stored in database 150, archived versions of the data stored in database 150, or any other type of data that may be indicative of, or associated with, the type of container(s) that may be loaded onto/into a vehicle.

The extended services server and the extended services server database(s) may be located at any geographical location, or distributed amongst a plurality of disparate geographical locations (e.g., cloud based server), so long as the extended services server and the extended services server database(s) may be sufficiently configured to facilitate interaction between the extended services server and the one or more of client computers 110 and/or the server 140. It is contemplated that in accordance with at least one aspect of the present disclosure that the extended services server and the extended services server database(s) may be located at any location that may be accessible by a caterer or airline staff such as, e.g., on-board a plane, at a rail yard, at a shipping port, at an airport, in a carrier's warehouse, in an airport warehouse, on a tarmac near an airport gate, on a mobile transport that travels between an airport warehouse and an airport gate, or any other location that may be accessible by, or associated with the caterer or airline staff. Alternatively, or in addition, the extended services server and the extended services server database(s) may be located on one or more vehicles.

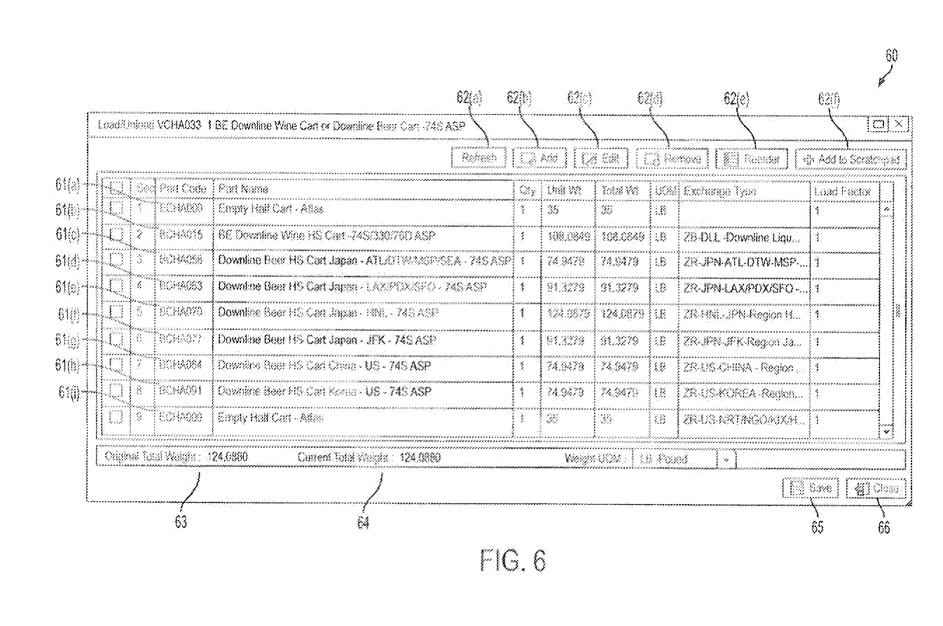

The client computer 110 may utilize one or more user interfaces to access the server 140 or the extended services server via the network 120 and one or more communication links 130 in order to perform one or more core data processing activities that may include accessing, storing, and/or manipulating data that resides in the database(s) 150 or the extended services server database in order to, among other things, for example, generate a loading plan report. The user interfaces may be graphical user interfaces that may include, among other things, e.g., the graphical user interfaces depicted in FIGS. 6, 7, and 8.

The generated loading plan report may be sent from either the client computer 110 or the server 140 to the extended services server. In the event that a loading plan report has previously been generated and sent to the extended services server by the client computer 110 or the server 140, the client computer 110 may access the extended services server directly in order to access and update the loading plan report, as necessary. However, if ample time is available to an individual (or a fully automated individual) utilizing the client computer 110, the client computer 110 may access the server 140, create an updated loading plan report, and send the updated loading plan report from the client computer 110 (or the server 140) to the extended services server in order to update the loading plan report maintained by the extended services server. Alternatively, or in addition, the client computer 110 (or the server 140) may send a generated loading plan report, or an updated loading plan report, directly to another client device 110 that may be associated with an individual (or a fully automated individual) that may be responsible for loading containers onto a vehicle. Once a loading plan report is obtained by a client computer 110, the server 140, or the extended services server, a hard copy of the loading plan configuration may be printed via one or more printers that may be coupled via one or more networks to the client computer 110, the server 140, or the extended services server, respectively. Moreover, the loading plan configuration may also be displayed on any client computer 110 (e.g., a mobile device, a laptop, a tablet, etc.) for quickly displaying the most up to date information and loading plan configuration to the caterer.

Client computer 110 may utilize one or more user interfaces to interact with server 140 or the extended services server in order to access, store, or otherwise manipulate data that resides in database(s) 150 or the extended services server's database(s) in order to, among other things, for example, submit or modify customer orders for a particular item that a user associated with client computer 110 may desire to receive on board a carrier's vehicle. The carrier may be, e.g., an airline company and the vehicle may include, e.g., an aircraft. In the event that a user submits or modifies a customer order that may be maintained in database(s) 150, the submitted or modified order may be communicated to the extended services server's database at some time prior to the departure of the customer's vehicle. However, it is contemplated that a client computer 110 may access the extended services server and the extended services server's database(s) directly in order to submit or modify customer orders at any time prior to the departure of the customer's vehicle or even during a customer's travel on/in the vehicle. Such in-transit submission or modification of orders may be particularly beneficial in situations where a customer may have, e.g., one or more connecting trips.

It is noted that there are numerous variations and modifications of the system of FIG. 1 that is described above that will be readily apparent to one skilled in the art in light of the present disclosure. For example, it is contemplated that customer orders for a particular item may be submitted at any time prior to the departure of a vehicle. This may include, e.g., a customer being prompted to submit a choice for a particular item when the customer places an order for, or otherwise purchases, a ticket. Alternatively, or in addition, it is contemplated that a carrier may be provided with the option of establishing a predetermined time period wherein customer orders may be submitted and/or modified. For example, a carrier may only allow a customer to submit and/or modify customer orders during a predetermined time period that begins at, or during, the time of purchase of a customer's ticket and up to, e.g., one hour before the scheduled departure time. Such custom, predetermined time periods may be established by the carrier in order to provide a sufficient amount of time for individuals working for, or operated by, the carrier to load the necessary containers on/in a vehicle that may sufficiently satisfy any received customer orders.

Database(s) 150 may be configured to store a container library that includes one or more records that may each be representative of a particular container. Each record in the container library may be described as a data structure (e.g., template container) that includes a conceptual grouping of one or more items that may be representative of a container of items that may be placed in a vehicle cart, loaded onto a vehicle, and made available to customers while the customers are onboard/in the vehicle. The items may include, e.g., equipment, entrees, snack foods, non-alcoholic drinks, alcoholic drinks, jewelry, books, magazines, or any other item that may be loaded into a vehicle cart. A container may include a single item such as, e.g., a coffee pot, an oven, a plate, etc. Alternatively, or in addition, a container may include a plurality of like items such as, e.g., a plurality of snack sized bags of potato chips. Alternatively, or in addition, a container may include a plurality of miscellaneous items such as, e.g., a plurality of soft drinks that include cola, diet cola, soda water, etc. Alternatively, or in addition, a container may be representative of an entire cart that includes one or more trays that may loaded/unloaded onto/from a vehicle.

Each container in the container library may, e.g., be associated with a container identifier that may, among other things, e.g., function as a universal identifier for a particular container. An individual or fully autonomous individual using client computer 110 may submit queries, based at least in part, on one or more container identifiers, against the container library in order to retrieve, update, or delete a container that is maintained in the container library, or particular attributes thereof.

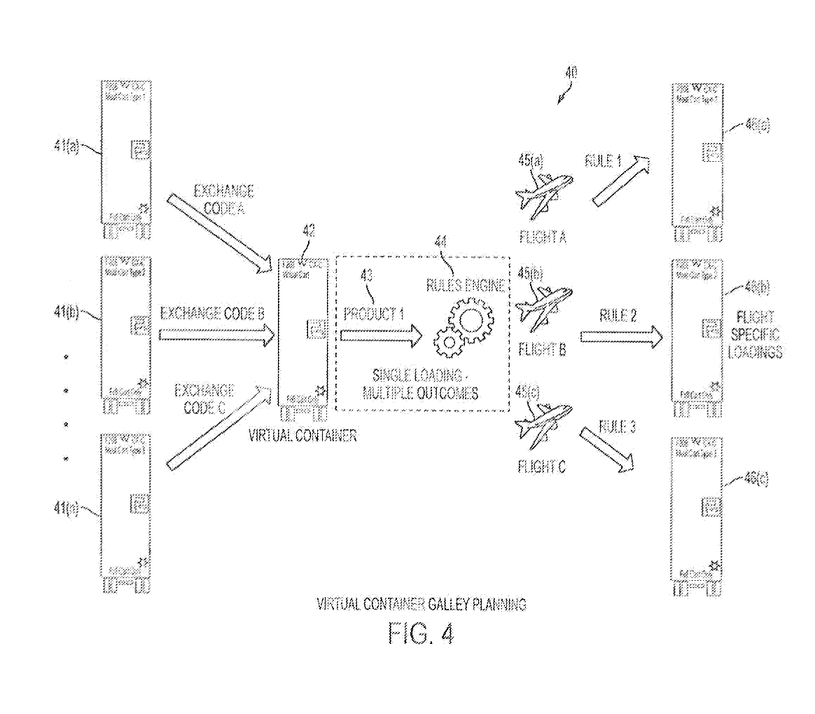

Database(s) 150 may be configured to store a library of virtual containers. A virtual container may be described as a conceptual data structure that may be configured to establish a logical relationship between one or more containers or one or more virtual sub-containers (described in more detail herein below). For example, an individual may utilize an interface such as, e.g., the interface depicted in FIG. 4 to assign or to associate one or more containers to a single virtual container. The individual may assign one or more containers to a single virtual container, for example, by selecting the container and virtual container with a user interface device (e.g., a mouse, touchscreen, keyboard, etc.), dragging and dropping the container onto a graphical depiction of a virtual container that may be provided by the system and representative of, e.g., an airline cart (vehicle cart), or any other suitable manner to associate a particular container with a particular virtual container. Alternatively, or in addition, for example, one or more input text boxes and/or drop down boxes may be used to facilitate the assigning of a particular container to a particular virtual container. Alternatively, or in addition, for example, server 140 or the extended services server may execute one or more algorithms in order to assign one or more particular containers to a particular virtual container. The one or more algorithms may utilize artificial intelligence, such as, for example, fuzzy logic, neural networks, or the like.

As previously described, virtual containers may establish a logical relationship between a plurality of containers. For example, there may be a non-alcoholic beverage virtual container that may be assigned containers that include a soft drink container, a juice container, a water container, and the like. Alternatively, or in addition, for example, there may be an alcoholic beverage virtual container that includes, e.g., a domestic beer container, an international beer container, a wine container, or the like. Alternatively, or in addition, there may be a breakfast foods virtual container that includes. e.g., a sausage container, a bacon container, a pancake container, or the like. Alternatively, or in addition, there may be a meals virtual container that includes, e.g., a cold breakfast food container, a hot breakfast food container, a lunch food container, and a dinner food container, or the like. However, no limitations on the types of containers that may be assigned to a particular virtual container should be inferred from the examples set forth herein. That is because, among other things, e.g., it is contemplated that even containers that are otherwise previously unrelated may be assigned to a single virtual container. Furthermore, it is contemplated that a virtual container may be assigned any number of containers wherein the numbers of containers that may be placed within any particular virtual container may only be constrained by, e.g., the data storage and memory limits of a particular computer system.

Each container may become associated with an exchange code after being assigned to a virtual container. An exchange code may, among other things, e.g., instruct an individual (or fully autonomous individual) regarding an appropriate action to take with respect to a particular container. For example, an exchange code EX may instruct an individual (or fully autonomous individual) to exchange a container. Alternatively, e.g., an exchange code NX may instruct an individual (or fully autonomous individual) not to exchange a container. Alternatively, e.g., an exchange code BX may instruct an individual (or fully autonomous individual) to exchange bar items of a particular container. However, it is contemplated that the present disclosure need not be so limited. As a result, it will be readily apparent to one skilled in the art in light of the instant disclosure that an exchange code may comprise any format (e.g., one or more numbers, one or more letters, one or more symbols, an alphanumeric mix, etc.) and may represent any action that may take place with respect to the loading/unloading of a container onto/from a vehicle, aircraft, vessel, railcar, etc.

At least one aspect of the present disclosure contemplates a rule-driven use of exchange codes to enhance the process of loading/unloading a vehicle. For example, an exchange rule may be defined that is associated with one or more exchange codes. When a particular exchange rule is triggered, one or more exchange codes may map the exchange rule criteria to one or more containers. This process may include, for example, the association of one or more exchange codes with one or more container identifiers. Therefore, an optimal subset of exchange codes and container identifiers may be identified for a particular trip (e.g., flight, rail trip, delivery route, etc.) after each exchange rule associated with a loading plan profile or rules engine is executed. The identified optimal subset of exchange codes and container identifiers may be included in, e.g., a loading plan report. However, it is contemplated that the present disclosure need not be so limited. As a result, it will be readily apparent to one skilled in the art in light of the present disclosure that exchange rules and exchange codes may be configured such that the triggering of a particular exchange rule may result in one or more exchange codes mapping rule criteria to one or more virtual sub-containers (described herein below).

Database(s) 150 may be configured to store a library of virtual sub-containers (or template sub-containers). A virtual sub-container may be described as a conceptual data structure that may be configured to establish a logical relationship between one or more containers for later assignment to a virtual container. The individual may assign one or more containers to a particular virtual sub-container by utilizing any method that would be known to one of ordinary skill in the art in view of the instant disclosure. Such methods may include the use of an interactive user interface.

Similar to assigning a container, an individual may, for example, select a container, drag and drop the container onto a graphical depiction of a virtual sub-container that is provided by the system and representative of, e.g., one or more trays of a vehicle cart. However, note that other means of associating a particular container with a particular virtual sub-container are also contemplated to fall within the scope of the present disclosure. Alternatively, or in addition, for example, one or more input text boxes and/or drop down boxes may be used to facilitate the assigning of a particular container to a particular virtual sub-container. Alternatively, or in addition, for example, server 140 or the extended services server may execute one or more algorithms in order to assign one or more containers to a particular virtual sub-container. The one or more algorithms may utilize artificial intelligence. Regardless of the assignment method that may be utilized, virtual sub-containers may provide a mechanism for the creation of nested containers that may provide a level of convenience by allowing an individual to create a reusable group of containers (and sub-containers) that may be added to a virtual container with a single command as opposed to, e.g., an individual adding each respective container to a virtual container individually, one-at-a-time.

The effectiveness of virtual sub-containers may be illustrated by way of example. Assume a scenario, for example, where an individual desires to associate a plurality of containers with a “snacks” virtual container. The individual may desire that the “snacks” virtual container include a plurality of different types of snacks including, e.g., peanuts, cookies, potato chips, pretzels, or the like. Further, each type of snack may include a plurality of different brands. For example, the different brands or type of cookies may include, e.g., a chocolate chip cookie, a peanut butter cookie, a sugar cookie, etc.

Without virtual sub-containers, an individual would be required to add each brand of snack for each type of snack. Assuming, by way of example, that an airline desires to offer four types of snacks and at least three brands for each type of snack, the airline must assign at least twelve containers to a “snacks” virtual container in order fully populate the snacks virtual container in accordance with the parameters of the example set forth herein.

Utilizing virtual sub-containers, an individual may create a peanuts virtual sub-container, a cookies virtual sub-container, a potato chips virtual sub-container, and a pretzels sub-container that may be stored in a virtual sub-container library in database(s) 150. Each respective virtual sub-container may conceptually group, e.g., all of the four different brands of a particular snack that an individual assigns to a virtual sub-container. In this continued example, this may result in the creation of four virtual sub-containers. Therefore, by utilizing virtual sub-containers, an individual could assign the same amount of snacks that required twelve assignment transactions without virtual sub-containers, by utilizing only four transactions with virtual sub-containers. Accordingly, the use of virtual sub-containers may ease the burden on a carrier's backend server 140 while also freeing up additional network bandwidth.

In light of the foregoing, the functionality described in accordance with at least one aspect of the present disclosure facilitates the creation of nested containers by utilizing virtual sub-containers. In addition, the present disclosure provides that both containers and virtual sub-containers may be assigned to a particular virtual container. Therefore, throughout the remainder of this disclosure when it is described that a container may be assigned to a virtual container, it should be understood that a virtual sub-container may also be similarly assigned, either by itself or in addition to another container(s). Accordingly, the term container and virtual sub-container may be used synonymously throughout the remainder of the written description of the present disclosure.

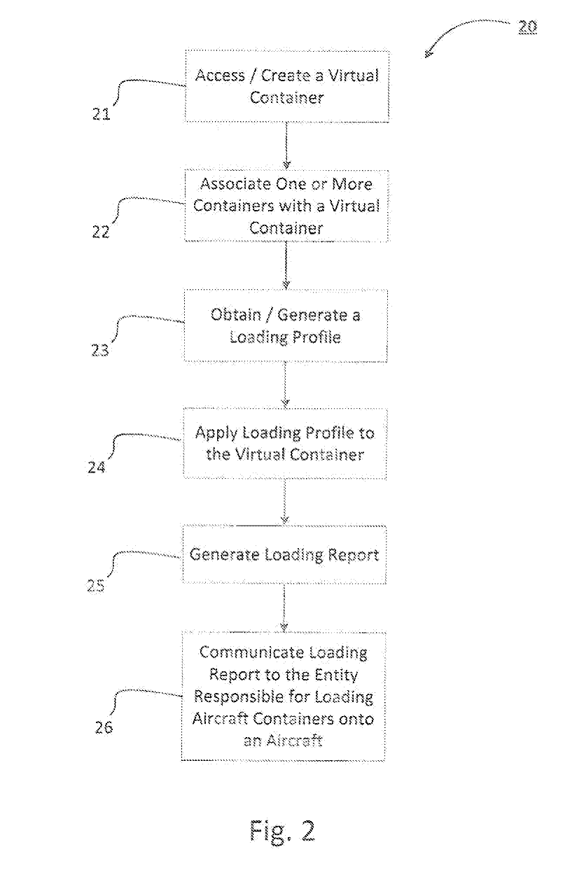

FIG. 2 shows an example of a process 20 for implementing rule based galley planning in accordance with one aspect of the present disclosure. The process 20 may begin at step 21 in which an individual selects a virtual container from a list of existing virtual containers, for example. The list of existing virtual containers may be provided in response to a query that may be submitted to server 140, for instance. After receiving the query, server 140 may search the virtual container library database that may be maintained by database 150. If the results of the query identify one or more virtual containers in the virtual container library, the identified virtual containers may be returned and used to populate a list of virtual containers. Alternatively, e.g., if the response to the query indicates that there are no virtual containers in the virtual container library, an individual may create a virtual container. A virtual container may be created utilizing, by way of example, the interface set forth in FIG. 4.

At step 22, as shown in FIG. 2, an individual may associate one or more containers with a virtual container. A container may become associated with a virtual container by assigning the container to a virtual container which may establish a logical relationship between each of the containers assigned to a respective virtual container. This logical relationship may create a pool of containers that may be analyzed together in order to identify a subset of one or more containers that may ultimately be selected for inclusion in a particular aircraft cart and then loaded onto an aircraft. Containers may be associated with a virtual container in a manner that is independent of flight schedule data including flight specific parameters (or flight attributes) such as destination port, arrival port, length of trip, arrival time, departure time, mileage, airline, aircraft type, etc. While containers assigned to a virtual container may typically be related in some manner (e.g., a non-alcoholic drinks virtual container may be assigned only containers that include non-alcoholic drink items), the containers added to a virtual container do not need to bear a specific relationship to each other. In fact, at least one aspect of the present disclosure contemplates that all known containers may be added to a single virtual container. Therefore, it is clear that a virtual container may be utilized to create a logical relationship between one or more containers which would otherwise not bear any substantial relationship to one another.

At step 23, a loading plan profile may be obtained. A loading plan profile may include data that is indicative of one or more containers that may be loaded aboard/on a particular vehicle, vessel, aircraft, etc. A loading plan profile may periodically be generated for each trip or flight. Each loading plan profile may be associated with a particular trip and include travel specific parameters or flight attributes that include, among other things, for example, a destination port, an arrival port, a length of trip, an arrival time, a departure time, flight mileage, etc. The trip information or flight attributes used to generate a particular loading plan may be obtained by submitting a query to a database that stores trip information (or flight attributes) for all trips scheduled to periodically arrive and/or depart from a respective location (e.g., port, airport, terminal, harbor, station, etc.). The database of trip information (or flight attributes) may be a database that stores the Standard Schedules Information Manual (SSIM). The SSIM may be maintained by database(s) 150, the extended services server's database(s), or a database that is maintained by a third party vendor and accessible via network 120 and one or more communications links 130. Server 140 may receive results of the query and generate a loading plan profile that may be obtained in order to facilitate rule based galley planning.

The loading plan profile may include one or more exchange rules. Exchange rules may utilize one or more travel (trip) specific parameters (or flight attributes) include, among other things, e.g., for example, a destination port, an arrival port, a length of trip, an arrival time, a departure time, mileage, etc. Each exchange rule may be associated with, among other things, one or more trip specific parameters and one or more exchange codes. Exchange rules may be constructed in an “If-Then” format that identifies particular criteria that must be satisfied, and then if satisfied, automatically triggers the addition of one or more particular container(s) in a loading plan report based, at least in part, on the exchanges codes that are also associated with the exchange rule. For example, an exchange rule may indicate that “if a flight departs in the morning and is scheduled for an hour long trip, then each passenger receives a muffin.” In accordance with this example, the exchange rule may be configured to dynamically determine based upon the time of day the flight is scheduled to leave and the duration of the flight, that an exchange code (e.g., a code that begins with an “EX”) should be associated with a container identifier for a container that includes muffins. The exchange code and the container identifier for a container that includes muffins may then be added to the loading plan report.

Alternatively, e.g., an exchange rule may indicate “if a flight departs in the morning and is scheduled for a three hour long trip, then each passenger receives a hot breakfast.” In accordance with this example, the exchange rule may be configured to determine based upon the time of day the flight is scheduled to leave and the duration of the flight, that an exchange code should be associated with a container identifier for a container that includes a hot breakfast. The exchange code and the container identifier for a container that includes hot breakfasts should be added to the loading plan report. However, it is contemplated that other types of exchange rules are intended to fall within the scope of the present disclosure. For example, any format of an exchange rule may be provided that facilitates the mapping of one or more trip specific parameters to one or more exchange codes.

At step 24, the loading plan profile may be applied to each respective virtual container. In this step, the exchange rules associated with a particular loading plan profile may function as a filter in order to identify an optimal subset of containers from one or more virtual containers. For example, a particular virtual container may identify each of the potential container options for a particular category of virtual container that may include, among other things, e.g., snacks, alcoholic drinks, non-alcoholic drinks, entrees, newspapers, magazines, books, equipment, etc. This may create a pool of all possible containers that may be considered for loading into a particular storage compartment within a particular vehicle prior to departure. Application of the exchange rules to each virtual container may facilitate the determination of the particular containers within each type of virtual container that correlate to the travel specific parameters for each particular trip as specified in the loading plan profile, thereby identifying an optimal subset of containers for inclusion in the loading plan profile.

At step 25, the optimal subset of containers may be aggregated, compiled, and used to generate a loading plan report. A loading plan report may include, e.g., information identifying an optimal set of containers that may be loaded on a particular trip. A loading plan report may include, among other things, e.g., the name of the cart, an exchange code, a graphical depiction of the cart, a graphical depiction of the containers within the cart, a textual list of container within the cart, etc. In addition, a loading plan report may include any information that may be conveyed to a caterer, or other individual, in order to obtain an optimal set of containers that may be loaded for a particular trip.

At step 26, the loading plan report (or loading plan configuration) may be transmitted to an entity that may be responsible for loading containers onto a vehicle, aircraft, vessel, etc. Specifically, e.g., server 140 may transmit an electronic copy of the loading plan report (or loading plan configuration) to a client computer 110 accessible by the caterer, or other individual, that may be responsible for loading containers onto the vehicle. After receiving the loading plan report, an individual may submit a command via client computer 110 in order to print a hard copy of the loading plan report. Alternatively, or in addition, a fully autonomous individual (e.g., an automated robot) may receive computer instructions from client computer 110, server 140, or the extended services server that are representative of a loading plan report and instruct one or more machines to load the identified optimal subset of containers onto the vehicle.

Alternatively, or in addition, the transmission of the loading plan report may include, e.g., transmitting a generated loading plan report from the client 110 or the server 140 to the extended services server that is at a location accessible to an entity that may be responsible for loading containers onto the vehicle. Once received at the extended services server, a hard copy of the loading plan report may be generated and given or sent to the caterer, or other individual, and used by the caterer, or other individual, to ensure that the optimal set of containers is loaded onto the vehicle. Alternatively, or in addition, the extended services server (or the server 140) may send an electronic message to an individual with a link to an electronic version of the loading plan report that may be hosted on the server 140 or the extended services server and accessible via the one or more client computers 110.

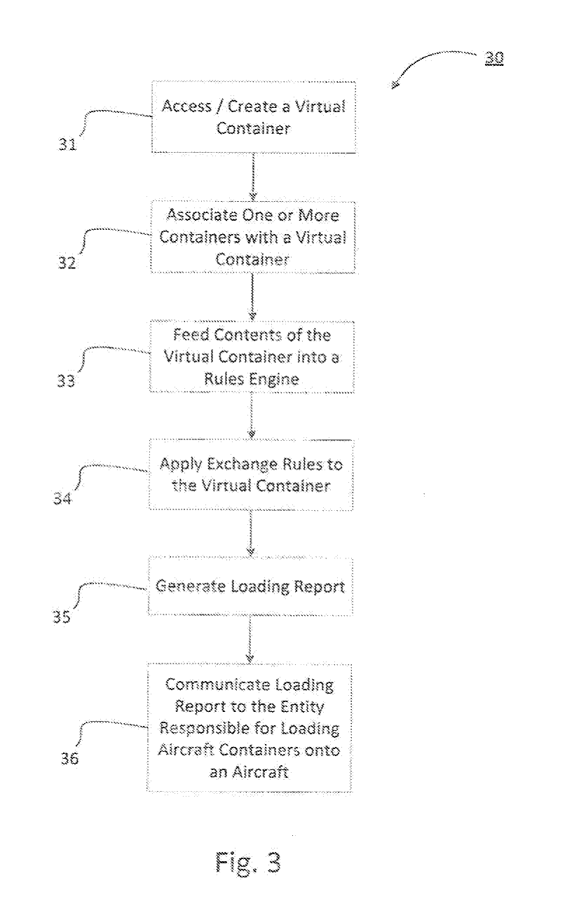

FIG. 3 illustrates an example of a process 30 for implementing rule based galley planning utilizing a rules engine in accordance with one aspect of the present disclosure. The process 30 may begin at step 31 when a virtual container is selected. The virtual container may be selected from, e.g., a list of existing virtual containers. The list of existing virtual containers may be provided in response to, e.g., a query that is submitted to the server 140. After receiving the query, the server 140 may search the virtual container library database that may be maintained by the database 150. If the results of the query identify one or more virtual containers in the virtual container library, the identified virtual containers may be returned and used to populate a list of virtual containers. If the response to the query indicates that there are no virtual containers in the virtual container library a virtual container does not yet exist, a user may either obtain one or more containers by downloading a virtual container library from a source of virtual container libraries that may be accessible via the network 120 and the communications links 130. The virtual container library may be provided by the carrier or some other source. Alternatively, e.g., if the response to the query indicates that there are no virtual containers in the virtual container library, an individual may create a virtual container. A virtual container may be created utilizing, by way of example, the interface set forth in FIG. 4.

At step 32, one or more containers may be associated with a virtual container. A container may become associated with a virtual container by, e.g., assigning the container to a virtual container. Assigning a container to a virtual container may establish a logical relationship between each of the containers assigned to a respective virtual container. This logical relationship may create a pool of containers that may he analyzed together in order to identify a subset of one or more containers that may ultimately be selected for inclusion in a particular aircraft cart and then loaded onto an aircraft. Containers may be associated with a virtual container in a manner that is independent of flight specific parameters such as destination port, arrival port, length of trip, arrival time, departure time, mileage, etc. While containers assigned to a virtual container may typically he related in some manner (e.g., a non-alcoholic drinks virtual container may be assigned only containers that include non-alcoholic drink items), the containers added to a virtual container do not need to bear a specific relationship to each other. In fact, at least one aspect of the present disclosure contemplates that all known containers may be added to a single virtual container. Therefore, it is clear that a virtual container may be utilized to create a logical relationship between one or more containers which would otherwise not bear any substantial relationship to one another.

At step 33, one or more virtual containers may be fed into a rules engine. The rules engine may include a plurality of exchange rules. Exchange rules may utilize one or more flight specific parameters or flight attributes including, among other things, e.g., for example, vehicle type, tail number, vehicle identification number, serial number, wear of manufacture of vehicle, destination port, arrival port, length of trip, arrival time, departure time, mileage of flight, etc. Each exchange rule may be associated with, among other things, one or more flight specific parameters and one or more exchange code. The exchange rules that comprise the rules engine may be generated as a result of one or more artificial intelligence algorithms that analyze trip specific parameters, as well as passenger data, in order to determine an optimal set of containers that may be loaded onto a vehicle. Such artificial intelligence algorithms may include the use of neural networks, machine learning, centralized agents, decentralized agents, that collect and analyze current trip specific data, current customer data, and real time container inventory in view of historical trip specific data, historical customer data, and historical recording of container waste, among other things, in order to determine an optimal set of containers that may be loaded onto a vehicle. The exchange rules used to construct the rules engine may be generated dynamically and change overtime as new data is obtained, and potentially viewed differently by the rule based galley planning system, in light of historical data that has been gathered, stored, mined, and otherwise analyzed over time. As a result, the rules engine may dynamically evolve with the passage of time in order to more accurately identify an optimal set of containers that may be loaded onto a vehicle.

Alternatively, or in addition, it is contemplated that the rules engine may be responsive to, and therefore adapt, in response to requests for specific items that may be associated with one or more containers. For example, an airline customer may be able to submit, or modify, a customer order for a specific item the airline customer may want delivered to the customer when the customer is on-board an aircraft. Such customer orders may be placed for any time including, among other things, e.g., food items, alcoholic drinks, non-alcoholic drinks, clothing, pillows, blankets, electronics, movies, video games, music, books, newspapers, or any other item offered for sale by a carrier. The customer order, or modification of an order, may be submitted via a client computer 110 to the server 140 or the extended services server. The customer order, or modification of an order, may be submitted at any time prior to departure, or within predetermined time periods as specified by the carrier. Once the customer order, or modification of an order, is received by a sever 140 or the extended services server, the rules engine may automatically generate a new exchange rule that designates the exchange codes for each container associated with a customer's order.

At step 34, the exchange rules may be applied to each respective virtual container that is fed into the rules engine. In this step, the exchange rules associated with rules engine may function as a filter in order to identify an optimal subset of containers from one or more virtual containers. For example, a particular virtual container identifies each of the potential container options for a particular category of virtual container that may include, among other things, e.g., snacks, alcoholic drinks, non-alcoholic drinks, entrees, newspapers, magazines, books, equipment, etc. This may create a pool of possible containers that may be considered for loading into a particular storage compartment within a particular vehicle prior to departure. Application of the exchange rules to each virtual container may facilitate the determination of the particular containers within each type of virtual container that correlate to the trip specific parameters and/or customer specific parameters for each particular trip as specified in the exchange rules, thereby identifying an optimal subset of containers for inclusion in the loading plan profile.

At step 35, the optimal subset of containers may be aggregated, compiled, and used to generate a loading plan report. A loading plan report may include, e.g., information identifying an optimal set of containers that may be loaded for a particular trip. A loading plan report may include, among other things, e.g., the name of the cart, an exchange code, a graphical depiction of the cart, a graphical depiction of the containers within the cart, a textual list of container within the cart, etc. In addition, it is contemplated that a loading plan report may include any information that may be conveyed to a caterer, or other individual, in order to obtain an optimal set of containers that may be loaded for a particular trip.

At step 36, the loading plan report may be transmitted to an entity that may be responsible for loading containers onto a vehicle. Specifically, e.g., server 140 may transmit an electronic copy of the loading plan report to a client computer 110 accessible by the caterer, or other individual, that may be responsible for loading containers onto the vehicle. After receiving the loading plan report, an individual may submit a command via client computer 110 in order to print a hard copy of the loading plan report. Alternatively, or in addition, a fully autonomous individual may receive computer instructions from client computer 110, server 140, or the extended services server that are representative of a loading plan report and instruct one or more machines to load the identified optimal subset of containers onto the vehicle.

Alternatively, or in addition, the transmission of the loading plan report may include, e.g., transmitting a generated loading plan report from client 110 or server 140 to the extended services server that is at a location accessible to an entity that may be responsible for loading containers onto the vehicle. Once received at the extended services server, a hard copy of the loading plan report may be generated and given to the caterer, or other individual, and used by the caterer, or other individual, to ensure that the optimal set of containers is loaded onto the vehicle. Alternatively, or in addition, the extended services server (or server 140) may send an electronic message to an individual with a link to an electronic version of the loading plan report that may be hosted on server 140 or the extended services server and accessible via one or more client computers 110.

FIG. 4 illustrates an example of a graphical depiction 40 that may be representative of aspects of a process for implementing rule based galley planning in accordance with one aspect of the present disclosure. The process may begin with an identification of each container 41(a)-41(n) that may potentially be loaded into a particular cart of an aircraft. After each container 41(a)-41(n) that may be associated with a particular cart of an aircraft is identified, an exchange code may be assigned to each container 41(a)-41(n). Each of the exchange codes may be associated with a virtual container 42 that may be representative of a particular cart of an aircraft. This virtual container 42 may therefore create a pool of containers that all the possible containers that may potentially be loaded into a particular airline cart.

The virtual container 42 may be fed into a rules engine 44 as “Product 1” 43, for example. After the virtual container 42 is received by the rules engine 44, one or more exchange rule may be applied to the virtual container 42 as a filter that may identify a pool of optimal containers for each respective outgoing flight 45(a)-45(c). The exchange rules may be generated based at least in part on, e.g., flight specific parameters, customer specific information, and real time container inventory. In addition, the exchange rules may dynamically evolve, as described herein, utilizing one or more artificial intelligence algorithms. After processing the input virtual container, the rules engine may output a loading plan report 46(a)-46(c) that may be identifying an optimal subset of container that may correspond to flight specific parameters and customer specific information that is particularly associated with each flight 45(a)-45(c), respectively.

Because of the sheer numbers of and the interrelated nature among the exchange rules, exchange codes, and the corresponding containers/sub-containers, the galley planning system 100 may implement system checks or tests to ensure that each exchange rule may be properly executed and that each container/sub-container is utilized. For example, the system 100 may implement a exchange rule check that determines i) instances of a specific exchange code being assigned to a specific container and/or a specific sub-container and ii) whether any of the exchange rules trigger or call the specific exchange code. The system 100 may record each flagged container, and as a result, may generate a list or a report that details each flagged container/sub-container that includes an exchange code that is never called by an exchange rule. Utilizing the list, the user may create additional exchange rules that call these flagged containers appearing on the list or may disassociate the container with the unutilized exchange codes.

Similarly, as another example, the system 100 may implement a check that determines one or more exchange rules that include exchanges codes that are not associated with any particular containers/sub-containers. For instance, if an exchange rule called a particular exchange code and the exchange code was not associated with any containers/sub-containers, the system 100 may flag the particular exchange rule and may even may generate a list of each flagged exchange rule. A user may use this list to delete the flagged exchange rule or may associate the affected exchange codes (as called by the exchange rule) to a specific container.

Because one or more hierarchical levels of sub-containers may be associated or loaded into a container (or a virtual container), the system 100 may additionally determine, for each sub-container that is associated with a container (or virtual container), whether an exchange type is assigned to the container. A user may determine which containers need to be assigned an exchange code based on the list of sub-containers that are associated with a container not assigned an exchange code.

Another report the system 100 may generate is a conflicting rules list. The system 100 may determine the containers (via the exchange codes) called by each exchange rule and may compare the containers called by the other exchange rules to determine whether an overlap is present. An overlap of containers occurs when two conflicting exchange rules both indicate that two respective and separate containers are to be placed in the same stowage location in the galley. If undetected, these conflicting rules may lead logistical issues, departure delays, or other problems for the carrier. For example, an instance of conflicting rules could result in a pilot refusing to fly due to insufficient passenger meals loaded in galley. Lastly, the system 100 may generate a complete overview of all the exchange rules and the containers affected by each of the exchange rule.

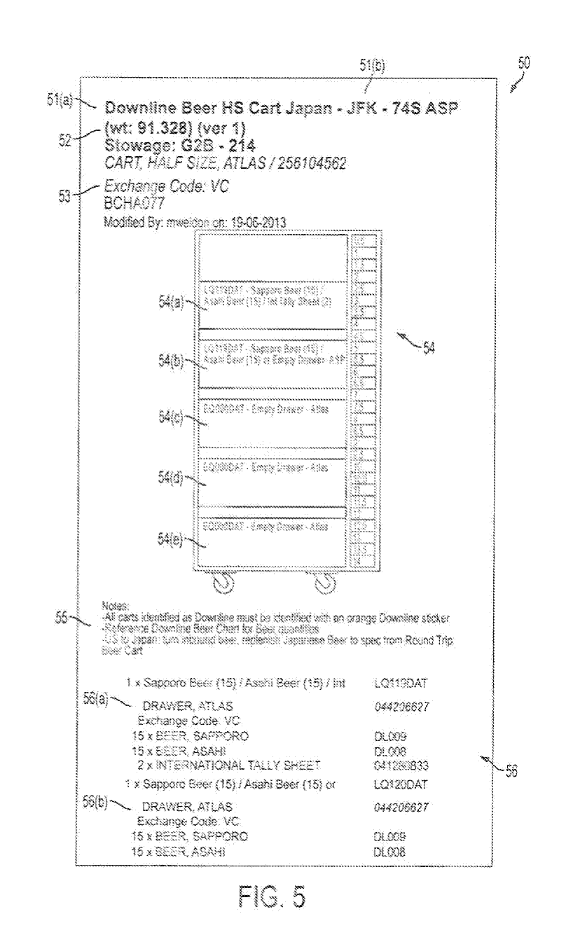

FIG. 5 illustrates an example of a loading plan report (or loading plan configuration) 50 in accordance with one aspect of the present disclosure. Loading plan report 50 may include, e.g., information identifying an optimal set of containers that may be loaded on a particular flight. Each page of loading plan report 50 may correspond to a particular airline cart. The information provided by loading plan report 50, may include, among other things, e.g., the name of the cart 51(a), flight identifying information 51(b), one or more cart attributes 52, an exchange code 53, a graphical depiction of the cart 54, a graphical depiction of the containers that may be loaded into the corresponding aircraft cart 54(a)-54(e), a message to assist an individual responsible for loading the containers into the aircraft 55, and a textual list 56 of containers 56(a), 56(b) that may be loaded into the corresponding aircraft cart. Accordingly, a loading plan report 50 may provide a single document that may provide a caterer, or other individual, with all the information that is necessary to identify the optimal subset of containers that may be loaded onto an aircraft.

FIG. 6 illustrates an example of a virtual container management interface 60 that may be used to manage the contents of a particular virtual container in accordance with one aspect of the present disclosure. The virtual container management interface 60 may include a row 61(a)-61(i) for each container that has been assigned to the virtual container associated with virtual container management interface 60. In addition, the interface may provide an individual with selectable controls via the virtual container management interface 60 that allows an individual to refresh the list of containers associated with the virtual container 62(a), add a container to the virtual container 62(b), edit a container that is currently associated with the virtual container 62(c), remove a container that is currently associated with the virtual container 62(d), reorder the list of containers associated with the virtual container 62(e), or an option to add a container to scratchpad 62(f). The virtual container management interface may provide an original total weight 62 and a current total weight 64. Virtual container management interface 60 may also provide, e.g., a save button 65 that may be selected to save changes made to the containers associated with the virtual container and a close button 66 that may be used to exit the virtual container management interface 60.

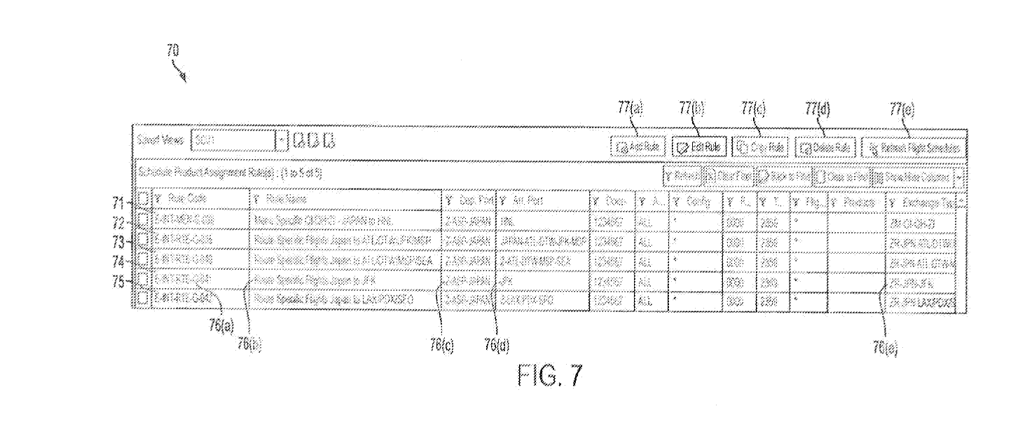

FIG. 7 illustrates an example of an exchange rule management interface 70 that may be used to manage exchange rules in accordance with at least one aspect of the present disclosure. The exchange rule management interface 70 may include a row 71-75 for each existing exchange rule. In addition, the exchange rule management interface 70 may provide an individual with selectable controls via the exchange rule management interface 70 that may allow an individual to add an exchange rule 77(a), edit an exchange rule 77(b), copy an exchange rule 77(c), delete an exchange rule 77(d), or refresh flight schedules. The selectable controls provided via exchange rule management interface 70 may be provided to facilitate manual manipulation of exchange rules that may be associated with a loading plan profile or rules engine. However, as described herein, one or more exchange rules may be dynamically created and may dynamically evolve over time. Such dynamically created and dynamically evolved rules may also be displayed via the exchange rule management interface. As a result, exchange rule management interface may provide an individual with a pool of exchange rules 71-75 that may be representative of the complete universe of exchange rules regardless of whether the exchange rules 71-75 were created manually or dynamically.

Information associated with each exchange rule 71-75 may also be displayed via exchange rule management interface 70. The information associated with each exchange rule 71-75 may include, among other things, for example, a rule code 76(a), a rule name 76(b), a departure port 76(c), an arrival port 76(d), and an exchange type 76(e). However, it is contemplated that other types of information may be associated with any particular exchange rule 71-75 and also displayed via exchange rule management interface 71-75. Other types of information may include, among other things, for example, any flights specific information, customer specific information, or any other date that may be used determine that a particular container should be added to a particular aircraft.

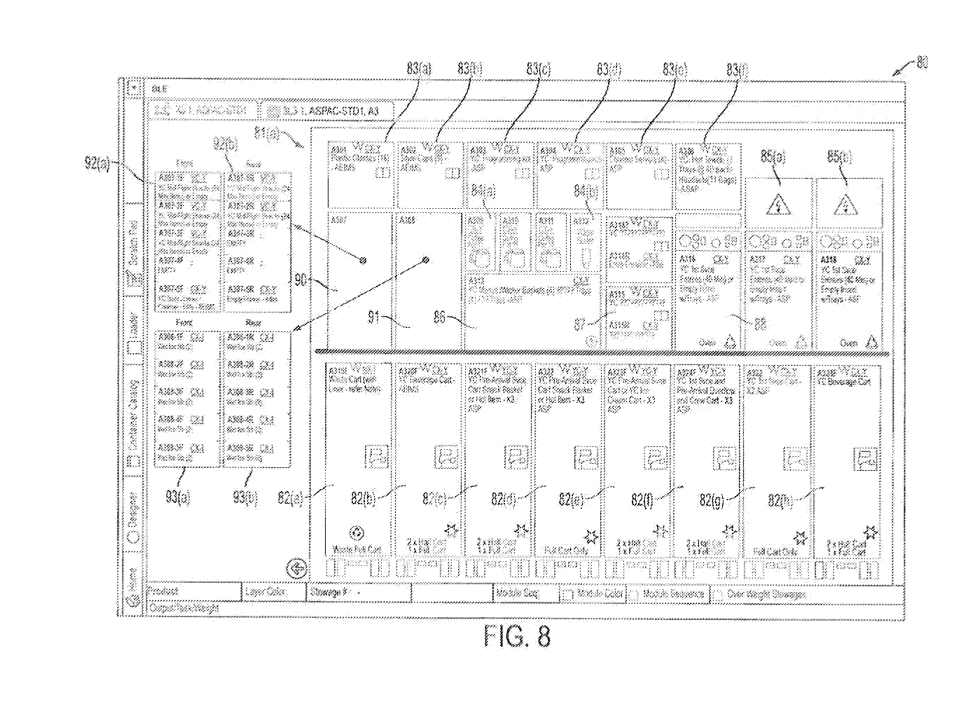

FIG. 8 illustrates an example of a galley planning interface 80 in accordance with one aspect of the present disclosure. Galley planning interface 80 may be used to facilitate the process of, e.g., associating one or more virtual containers to a particular aircraft. Associating one or more virtual containers to particular aircraft may include, among other thing, e.g., assigning a virtual container to one or more storage locations of an aircraft. At some point in time after virtual containers are assigned to one or more aircraft storage locations via galley planning interface 80, and prior to departure of the aircraft, one or more exchange rules may be applied to each virtual container. The exchange rules may be applied to each virtual container in a variety of different ways utilizing any algorithm that would readily be apparent to one of ordinary skill in the art in view of the present disclosure including, among other ways, for example, the processes identified by FIG. 2 and FIG. 3 of the present disclosure.

Galley planning interface 80 is one of a plurality of interfaces that may be created to implement the rule based galley planning system of the present disclosure. Each galley planning interface such as, e.g., galley planning interface 80, may be configured to correlate to the precise specification of each aircraft galley for every aircraft in an airline company's fleet. Such interfaces may be downloaded from a server, such as, e.g., server 140, a corporate headquarters server, the extended services server, or one or more third party servers, that may be accessed via network 120 and one or more communication links 130. Alternatively, or in addition, a galley planning interface such as, e.g., galley planning interface 80, may be created from scratch by an individual using any one or more graphical interface design tools including, but not limited to, e.g., Microsoft Visio, etc.

Galley planning interface 80 may accept user interaction with the galley planning tool by facilitating, e.g., drag and drop controls. For example, galley planning interface may include one or more aircraft galley storage locations 90, 91 that may be configured to receive one or more containers 92, 93. Galley planning interface 80 facilitates a graphical view of both the front end of a virtual container 92(a), 92(b) and the back end of a virtual container 93(a), 93(b). One or more virtual containers 92, 93 may be associated with a particular aircraft galley storage location 90, 91 respectively. This association between a virtual container 92, 93 with a particular galley storage location 90, 91 may be achieved by, e.g., dragging and dropping the virtual container 92, 93 onto the aircraft galley storage location 90, 91. It is noted that other means of associating a virtual container with an aircraft galley storage location are also contemplated to fall within the scope of the present disclosure. Alternatively, or in addition, for example, one or more input text boxes and drop down boxes may be used to facilitate the assigning of a virtual container with an aircraft galley storage location. Alternatively, or in addition, for example, server 140 or the extended services server may execute one or more algorithms in order to assign one or more virtual containers with an aircraft galley storage location. The one or more algorithms may utilize artificial intelligence.

Galley planning interface 80 may be configured to facilitate the addition of virtual containers of varying sizes and shapes. Virtual containers may be configured to accommodate the varying sizes and shapes of each respective galley storage location of each respective aircraft galley. For example, there may be large virtual containers 82(a)-82(h), medium virtual containers 86, 87, 88, 92, 93, small virtual containers 83(a)-83(f), and even smaller virtual containers 84(a), 84(b) that may be sized and shaped to accommodate a particular piece of equipment such as, e.g., a coffee pot. Such virtual containers may be specifically sized and shaped to correspond to large aircraft galley storage locations, medium aircraft galley storage locations, small aircraft galley storage locations, and smaller aircraft galley storage locations that may be configured to receive a particular piece of equipment such as, e.g., a coffee pot. Furthermore, galley planning interface 80 may facilitate the creation of aircraft galley storage locations that may correspond to, among other things, e.g., utility closets 85(a), 85(b). In addition to the examples set forth herein, it is also contemplated that there may exist virtual containers and corresponding aircraft galley storage locations that may be provided in a variety of other shapes and sizes.

Moreover, the gallery planning interface 80 may further receive updated galley data from the galley planning system 100, such as detection data that indicates whether a properly assigned container is present and/or properly situated in a particular aircraft galley storage location. For example, an aircraft galley storage location within a galley of an aircraft may include detector that is capable of detecting the presence of a container within the galley storage location. For example, the detector may sense a radio frequency identification (RFID) tag within a container, may detect a flux between two magnetic elements coming into close contact, may detect a Bluetooth Low Energy (BLE) signal via a BLE beacon, or any other suitable means to detect the presence of a container situated in galley storage location. For example, a container may be placed within the aircraft galley storage location, and in response, the BLE beacon and the container may communicate together to make the BLE beacon within the storage location aware of the presence of the container (e.g., the coffee pot). Continuing this example, the BLE beacon may transmit a container notification for this particular coffee pot container to the galley planning system 100, specifically the server 140. In turn, the server 140, in this continued example, may send the notification to the galley planning interface 80 for displaying the notification. Moreover, this detector system may be implemented at the container and sub-container level to determine whether the correct number of sub-containers are present in a particular container or whether the proper number of cans of soda, pieces of flatware, or even slices of apple are present in one or more sub-containers. Furthermore, this inventory data collected from the detection system may be further utilized in determining loading plan configurations, packing lists, etc. in more dynamic manner. For example, inventory data may be collected from a particular vessel mid-flight and transmitted to the system 100 for use in determining the loading plan configuration for future flights of the vessel.

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer,” as used in this disclosure, means any machine, device, circuit, component, or module, or any system of machines, devices, circuits, components, modules, etc., which are capable of manipulating data according to one or more instructions, such as, for example, without limitation, a processor, a microprocessor, a central processing unit, a general purpose computer, a super computer, a personal computer, a laptop computer, a palmtop computer, a tablet computer, a smart phone, a notebook computer, a desktop computer, a workstation computer, a server, etc., or an array of processors, microprocessors, central processing units, general purpose computers, super computers, personal computers, laptop computers, palmtop computers, notebook computers, desktop computers, workstation computers, servers, etc.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (1R) communication link, an optical communication link, or the like, without limitation. The RF communication link may include, for example, WiFi, WiMAX, IEEE 802.11, DECT, OG, IG, 2G, 3G or 4G cellular standards, Bluetooth, and the like.

A “network,” as used in this disclosure means, but is not limited to, for example, at least one of a local area network (LAN), a wide area network (WAN), a storage area network (SAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

A “caterer,” as used in this disclosure means, but is not limited to, for example, an individual, a group of individuals, an entity, or the like, who works for, or is otherwise associated with, a carrier, such as, for example, an airline, a shipping company, a cruise ship, a railway line, or the like, that may be responsible for facilitating galley planning activities associated with one or more trips (e.g., flights, cruises, rail-trips, or the like). Alternatively, or in addition, a caterer may be, for example, any individual, group of individuals, or entity that receives, or may be configured to receive and interpret, a loading plan report.

An “individual,” as used in this disclosure means, but is not limited to, for example, a human, artificially intelligent software (e.g., fuzzy logic, neural networks, or the like), a fully automated, robotic entity, or a plurality of fully automated, networked, robotic entities.

A “carrier,” as used in this disclosure means, but is not limited to, for example, an airline, an airline company, a shipper, a shipping company, a cruise ship, a railroad company, a trucker, a trucking company, a bus company, a third party that provides or facilitates carrier services, or the like.

A “vehicle,” as used in this disclosure means, but is not limited to, for example, an airplane, an aircraft, a watercraft, a ship, a boat, a truck, a trailer, a bus, a locomotive, a locomotive car, a van, a recreational vehicle, an automobile, or the like.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., tens of, hundreds of, or thousands of) memory caches on multiple (e.g., tens of, hundreds of, or thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, OG, IG, 2G, 3G or 4G cellular standards, Bluetooth, or the like.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Still further, the figures depict preferred embodiments of an automated content ETL system for purposes of illustration only. One skilled in the art will readily recognize from the foregoing discussion that alternative embodiments of the structures and methods illustrated herein may be employed without departing from the principles described herein. Thus, upon reading this disclosure, those of skill in the art will appreciate still additional alternative structural and functional designs for a system and a process for automatically extracting, transforming, and loading content data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications or modification of the disclosure.

What is claimed:

1. A computer-implemented method for generating a loading plan configuration for loading a galley of a flight, the method comprising:
receiving, via a digital communication network, flight schedule data for a flight, the flight schedule data including a plurality of flight attributes associated with the flight;
in response to receiving the flight schedule data, determining one or more exchange rules based on the received plurality of flight attributes associated with the flight;
determining one or more exchange codes based on each of the determined one or more exchange rules, the one or more exchange codes associated with the flight;
determining one or more template containers that are associated with each of the one or more exchange codes;
determining a particular container that corresponds to each of the one or more template containers, each container corresponding to a tangible item capable of being loaded into an aircraft;
generating a loading plan configuration that indicates i) a list that includes each determined particular container to be loaded and ii) a location within the galley of the aircraft for each determined particular container to be stored; and
transmitting, via the digital communication network, the loading plan configuration for the flight.

2. The method of claim 1, further comprising:
determining one or more template sub-containers associated with each determined template container; and
determining a particular sub-container that corresponds to each of the one or more template sub-containers, each sub-container corresponding to a tangible item capable of being loaded into an aircraft.

3. The method of claim 1, wherein the loading plan configuration includes a galley diagram that indicates the proper position of each container and sub-container within the gallery.

4. The method of claim 1, further comprising:
generating a packing diagram that indicates i) a packing list that includes each item to be packed into each container and ii) a location within the container of each item.

5. The method of claim 4, wherein the packing list further includes each item to be packed into each sub-container.

6. The method of claim 1, wherein the flight attributes include at least one of vehicle type, tail number, vehicle identification number, serial number, wear of manufacture of vehicle, destination port, arrival port, length of trip, arrival time, departure time, or mileage of flight.

7. The method of claim 1, further comprising:
receiving, via the digital communication network, an updated flight schedule data, the flight schedule data including a plurality of updated flight attributes associated with the flight;
determining flight attribute changes between the flight attributes and the updated flight attributes; and
generating a loading plan configuration based on the flight attribute changes.

8. The method of claim 1, further compromising:
receiving a notification of the presence of a container within a galley storage location.

9. The method of claim 8, further compromising:
transmitting the notification in conjunction with an updated loading plan configuration.

10. A computer-readable medium having instructions stored thereon and executable by one or more processors to perform a method for generating a loading plan configuration for loading a flight galley, the method comprising:
receiving, via a digital communication network, flight schedule data for a flight, the flight schedule data including a plurality of flight attributes associated with the flight;
in response to receiving the flight schedule data, determining one or more exchange rules based on the received plurality of flight attributes associated with the flight;
determining one or more exchange codes based on each of the determined one or more exchange rules, the one or more exchange codes associated with the flight;
determining one or more template containers that are associated each of the one or more exchange codes;
determining a particular container that corresponds to each of the one or more template containers, each container corresponding to a tangible item capable of being loaded into an aircraft;
generating a loading plan configuration that indicates i) a list that includes each determined particular container to be loaded and ii) a location within the galley of the aircraft for each determined particular container to be stored; and
transmitting, via the digital communication network, the loading plan configuration for the flight.

11. The computer-readable medium of claim 10, wherein the method further comprising:
determining one or more template sub-containers associated with each determined template container; and
determining a particular sub-container that corresponds to each of the one or more template sub-containers, each sub-container corresponding to a tangible item capable of being loaded into an aircraft.

12. The computer-readable medium of claim 10, wherein the loading plan configuration includes a galley diagram that indicates the proper position of each container and sub-container within the gallery.

13. The computer-readable medium of claim 10, wherein the method further comprising:
generating a packing diagram that indicates i) a packing list that includes each item to be packed into each container and ii) a location within the container of each item.

14. The computer-readable medium of claim 13, wherein the packing list further includes each item to be packed into each sub-container.

15. The computer-readable medium of claim 10, wherein the flight attributes include at least one of vehicle type, tail number, vehicle identification number, serial number, wear of manufacture of vehicle, destination port, arrival port, length of trip, arrival time, departure time, or mileage of flight.

16. The computer-readable medium of claim 10, the method further comprising:
receiving, via the digital communication network, an updated flight schedule data, the flight schedule data including a plurality of updated flight attributes associated with the flight;
determining flight attribute changes between the flight attributes and the updated flight attributes; and
generating a loading plan configuration based on the flight attribute changes.

17. The computer-readable medium of claim 10, the method further compromising:
receiving a notification of the presence of a container within a galley storage location.

18. The computer-readable medium of claim 17, the method further compromising:
transmitting the notification in conjunction with an updated loading plan configuration.
